(19) United States
(12) Patent Application Publication
(10) Pub. No.: US 2019/0146722 A1
(43) Pub. Date: May 16, 2019

(54) CONTENT MANAGEMENT

(71) Applicant: Hewlett-Packard Development Company, L.P., Houston, TX (US)

(72) Inventors: Randall Edward Grohs, Boise, ID (US); Yaze Wang, Boise, ID (US); Ian Dallas, Boise, ID (US)

(21) Appl. No.: 16/097,363

(22) PCT Filed: Jul. 15, 2016
(86) PCT No.: PCT/US2016/042654

§ 371 Date: Oct. 29, 2018

(51) Int. Cl. G06F 3/12; H04L 29/08; H04N 1/00

(52) U.S. Cl. CPC G06F 3/122; G06F 3/1224; H04L 67/18; G06F 3/1288; G06F 3/1236; H04N 1/00244; H04L 67/1097

(57) ABSTRACT

According to examples, content management may include receiving, at an on-premise location and from a cloud environment, instructions to perform an operation on content. The instructions may be previously received at the cloud environment and further evaluated at the cloud environment to determine, based on a plurality of policies associated with the instructions, whether to perform the operation using a cloud-based resource or whether to perform the operation using an on-premise resource that is at the on-premise location. In response to a determination, at the cloud environment, that the operation is to be performed using the on-premise resource, the instructions are forwarded from the cloud environment to the on-premise location. Further, content management may include performing, at the on-premise location and based on the received instructions, the operation on the content using the on-premise resource.

### BACKGROUND INFORMATION

Cloud computing may be described as computing that provides shared processing resources and data to computers and other devices on demand via the Internet. In the cloud computing environment, a shared pool of configurable computing resources such as networks, servers, storage, applications, services, etc., may be provisioned and released based on the demand for such resources. Cloud computing may be used to store and process data in third-party data centers.

### BRIEF DESCRIPTION OF DRAWINGS

Features of the present disclosure are illustrated by way of examples shown in the following figures. In the following figures, like numerals indicate like elements, in which:

FIG. 1 illustrates an architecture of a content management apparatus, according to an example of the present disclosure;

FIG. 2 illustrates an environment including the content management apparatus of FIG. 1, according to an example of the present disclosure;

FIG. 3 illustrates a pull-print operation for the content management apparatus of FIG. 1, according to an example of the present disclosure;

FIG. 4 illustrates a capture and route operation for the content management apparatus of FIG. 1, according to an example of the present disclosure;

FIG. 5 illustrates a flowchart of a method for content management, according to an example of the present disclosure;

FIG. 6 illustrates a flowchart of another method for content management, according to an example of the present disclosure; and

FIG. 7 illustrates a flowchart of a further method for content management, according to an example of the present disclosure.

### DETAILED DESCRIPTION

For simplicity and illustrative purposes, the present disclosure is described by referring mainly to examples thereof. In the following description, details are set forth in order to provide an understanding of the present disclosure. It will be readily apparent however, that the present disclosure may be practiced without limitation to these details. In other instances, methods and structures apparent to one of ordinary skill in the art have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

According to examples of the present disclosure, a content management apparatus and a method for content management are disclosed herein. The apparatus and method disclosed herein may provide functionalities of an on-premise content solution and a cloud-based content solution.

An on-premise content solution may be described as a solution where a user installs, configures, maintains, and supports on-premise set of machine readable instructions on hardware that has been provisioned. In this regard, content management may become challenging due to the need to install, configure, maintain, and support the on-premise set of machine readable instructions, and to provision the associated hardware.

For a cloud-based content solution, all content is sent through a network to an external cloud. In this regard, content management may become challenging due to the need to send content to the cloud and back. For example, the cost of sending large amounts of content data to and from the cloud may be relatively high. For example, the cost of sending large amounts of content data may be associated with increased bandwidth usage. If a connection to the cloud is slow, or fails, performance or reliability of the cloud-based content solution may be affected. In this regard, an internal network may be comparably faster relative to a connection to a cloud. Further, security concerns may also limit the desirability of use of a cloud-based content solution where all content is send through a network to the external cloud, as opposed to storage at an on-premise location.

In order to address the aforementioned technical challenges with respect to on-premise content solutions and cloud-based content solutions, the apparatus and method disclosed herein may implement a hybrid approach to the processing and routing of content, resulting in the ability to operate in a cloud-based content solution manner, while also controlling where content is routed to comply with cost, performance, or security specifications.

The term content as used herein may be used to describe any type of audio, video, graphic, documentary, and other such types of content that is to be manipulated, routed, and/or processed in any manner.

The apparatus disclosed herein may operate as an on-premise agent that coordinates with cloud-based machine readable instructions. The term on-premise may be used to describe a location that is, for example, at a facility where the apparatus disclosed herein is installed on an appliance. The term appliance may be used to describe hardware that includes the apparatus installed thereon, where the appliance may be provisioned by a user of the apparatus disclosed herein and installed at the user's facility. In this regard, the apparatus may be deployed on the appliance that, other than being installed, does not need intervention at the on-premise location. The appliance may provide computing and storage assistance with respect to operation of the apparatus. The apparatus may handle content storage and processing, thus eliminating the need for a user to use the cloud-based content solution directly.

The apparatus and method disclosed herein may provide various technical benefits. For example, a user may implement the apparatus and method disclosed herein at the user's premise without the need to manage associated server hardware, installation, configuration, maintenance, and support of licensed machine readable instructions. For example, the apparatus may be installed on the appliance that a user may power on and connect to the Internet, with the appliance performing the configuration, maintenance, and licensing related to the apparatus and method disclosed herein.

Further, the apparatus and method disclosed herein, when installed on the appliance that is provisioned by a user, may be managed by a third-party cloud management solution. Thus, a user may be use the apparatus and method disclosed herein in the form of an appliance, without the need to manage the operation of the appliance or operations of the apparatus and method disclosed herein.

The apparatus and method disclosed herein may provide savings of Internet related usage by minimizing usage of external networks. For example, the apparatus and method disclosed herein may reduce network bandwidth usage.

The apparatus and method disclosed herein may increase performance related to content (e.g., document) operations by using a faster internal network when needed instead of external networks (e.g., networks associated with the cloud environment) when possible.

The apparatus and method disclosed herein may increase reliability with respect to content operations, for example, by continuing on-premise processing via the apparatus and method disclosed herein, even if the cloud connection is lost.

The apparatus and method disclosed herein may provide for increased security, for example, by preventing sensitive data from travelling outside of a specified firewall.

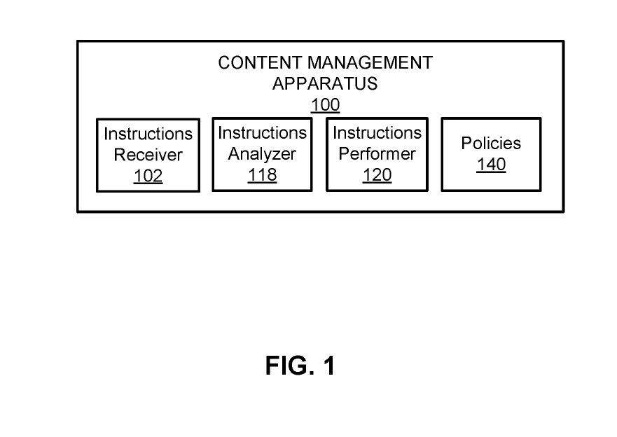

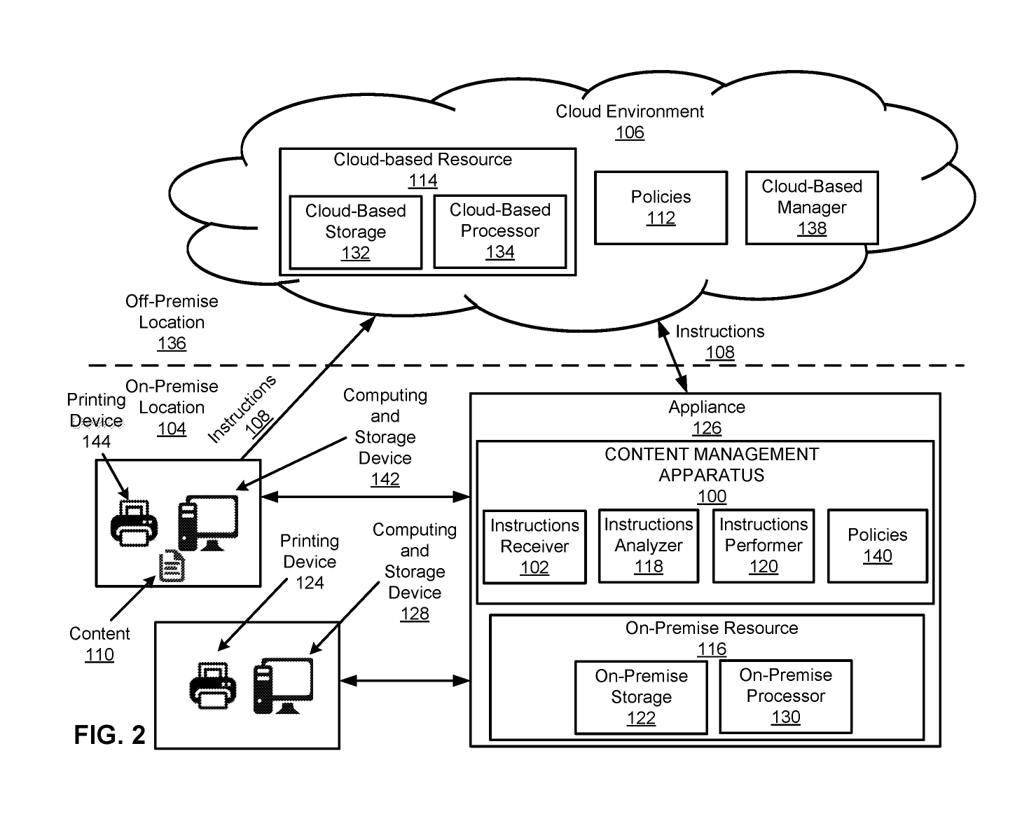

FIG. 1 illustrates an architecture of a content management apparatus 100, according to an example of the present disclosure. FIG. 2 illustrates an environment including the content management apparatus 100, according to an example of the present disclosure.

Referring to FIGS. 1 and 2, the apparatus 100 may include an instructions receiver 102 to receive, at an on-premise location 104 and from a cloud environment 106, instructions 108 to perform an operation on content 110. The instructions 108 to perform the operation on the content 110 are previously received at the cloud environment 106 and further evaluated at the cloud environment 106 to determine, based on a plurality of policies 112 associated with the instructions 108 to perform the operation on the content 110, whether to perform the operation using a cloud-based resource 114 or whether to perform the operation using an on-premise resource 116 that is at the on-premise location 104. Further, in response to a determination, at the cloud environment 106, that the operation is to be performed using the on-premise resource 116, the instructions 108 to perform the operation on the content 110 are forwarded from the cloud environment 106 to the on-premise location 104.

A set of the policies 112 (illustrated as policies 140) may be similarly provided in the apparatus 100 to operate independently of the cloud environment 106, for example, in the event of network outage.

An instructions analyzer 118 of the apparatus 100 may analyze the instructions 108 to determine a type of the instructions as disclosed herein, for example, with respect to pull-printing and capture and routing.

An instructions performer 120 of the apparatus 100 may perform, at the on-premise location 104 and based on the received instructions 108 to perform the operation on the content 110, the operation on the content 110 using the on-premise resource 116.

With respect to pull-printing, the instructions analyzer 118 may determine, at the on-premise location 104, whether the instructions 108 to perform the operation on the content 110 include pull-print instructions. In response to a determination, at the on-premise location 104, that the instructions 108 to perform the operation on the content 110 include the pull-print instructions, the content 110 may be stored at the on-premise resource 116 that includes an on-premise storage 122. Further, upon receipt of a request from a printing device 124 at the on-premise location 104, the stored content 110 may be forwarded from the on-premise storage 122 to the printing device 124.

An appliance 126 provided at the on-premise location 104 may be used to store the content 110 at the on-premise resource 116 that includes the on-premise storage 122.

With respect to capture and routing, the instructions analyzer 118 may determine, at the on-premise location 104, whether the instructions 108 to perform the operation on the content 110 include capture and route instructions. In response to a determination, at the on-premise location 104, that the instructions to perform the operation on the content 110 include the capture and route instructions, a scanned version of the content 110 may be received and stored at the on-premise resource 116 that includes the on-premise storage 122, and routed, based on an analysis of the scanned version of the content 110 at the on-premise location 104, to a further on-premise storage (e.g., the computing and storage device 128). The scanned version of the content 110 may be analyzed by an on-premise processor 130.

The cloud-based resource 114 may similarly include a cloud-based storage 132 and a cloud-based processor 134 which perform functions similar to the on-premise storage 122 and the on-premise processor 130, but at the cloud environment 106 in an off-premise location 136.

Based on the foregoing, the apparatus 100 may implement a hybrid deployment scenario that optimizes where the content 110 is routed based on the configurable policies 112 (or the policies 140 as disclosed herein) to meet various potential objectives. The apparatus 100 (or a plurality of instantiations of the apparatus 100) may coordinate with a cloud-based manager 138 of the cloud environment 106. In this regard, a plurality of instantiations of the apparatus 100 may be used for purposes, such as load-sharing and redundancy for reliability. With respect to coordination with the cloud-based manager 138, as disclosed herein, the apparatus 100 may scan (e.g., with respect to capture and route) the content 110 to a local (i.e., on-premise) destination. In this regard, the scanned content 110 remains on-premise, with the coordination of the scanning occurring with the cloud-based manager 138.

The apparatus 100 may be deployed on the appliance 126. Alternatively, a plurality of instantiations of the apparatus 100 may be deployed on the appliance 126, or each appliance 126 may include a single instantiation of the apparatus 100. The appliance 126 may be supported and managed via the cloud-based manager 138. For example, a new version of code with respect to a component of the apparatus 100 may be implemented to update the apparatus 100. An example of a new version of code may include anti-virus machine readable instructions, and other such machine readable instructions. The cloud-based manager 138 may also control a configuration of the apparatus 100. Thus, the apparatus 100 may be operated without any user intervention at the on-premise location 104. If needed, a user at the on-premise location 104 may monitor the apparatus 100 via a user-interface of the apparatus 100. In the event that there is any type of loss of Internet or another connection, the cloud-based manager 138 may send a notification to an administrator of the apparatus 100.

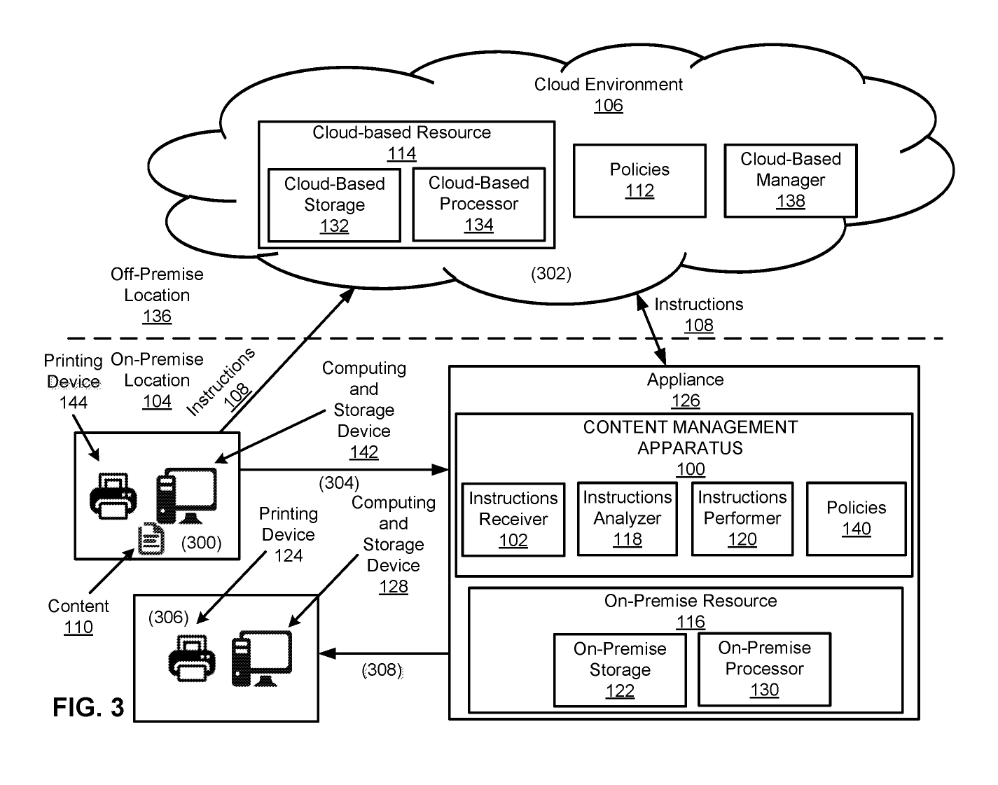

The apparatus 100 may provide additional computing and storage assistance. For example, as disclosed herein with respect to FIG. 3, if a pull-print job were to be stored locally, a print driver user interface communication of the computing and storage device 142 may occur with the cloud-based manager 138, and a desktop driver of the computing and storage device 142 will route the content 110 to the on-premise storage 122 instead of the cloud-based storage 132.

Once the apparatus 100 is implemented at the on-premise location 104, a user of the apparatus 100 may register the apparatus 100 with the cloud-based manager 138. Once the apparatus 100 is registered with the cloud-based manager 138, a discovery manager of the apparatus 100 may identify any appliance (e.g., the appliance 126) associated with the apparatus 100 and register the appliance with the cloud-based manager 138. In this regard, a dashboard on the cloud-based manager 138 may provide for initialization of the apparatus 100 and/or the appliance 126. Thus, the overall system including the apparatus 100, the appliance 126, and the cloud-based manager 138 makes use of the additional on-premise resource (e.g., the on-premise storage 122 and the on-premise processor 130, and other such resources).

FIG. 3 illustrates a pull-print operation for the apparatus 100, according to an example of the present disclosure.

Referring to FIG. 3, pull-printing stores content after uploading, until a user uses a device (e.g., a desktop printer) to print the content 110. Pull printing is a printing feature where a user's print job is held on a server or on a user's workstation, and released by the user at any printer (i.e., pulled to the printer) which supports this feature. The user may first authenticate themselves at the printing device 124, for example, by using embedded machine readable instructions (e.g., a pin code), or an external device (e.g. a smartcard). Once the user has been authenticated, the user may select from the list of print jobs from the server, web portal, or directly from the user PC, which print job they wish to release at the printing device 124. Pull-printing adds security to the content printing process because the content 110 does not stay in an output bin of the printing device 124 before the user gets to the printed content. In this regard, once the user is at the printing device 124, the user may print and retrieve the content once at printing device 124.

For the pull-printing process using the apparatus 100, as shown in FIG. 3, at 300 (illustrated as (300) in FIG. 3), a user may access the content 110, for example, via the computing and storage device 142. The user may access the content 110 via a user interface, which leads to the content storage. The user may request printing of the content 110 from the computing and storage device 142. At this stage, the printer driver of the computing and storage device 142 may connect to the cloud-based manager 138 and login the user. The cloud-based manager 138 may instruct the driver to use the on-premise resources instead of transmitting the content 110 to the cloud environment 106.

At 302, the cloud-based manager 138 may coordinate the use of the on-premise resource 116 for storage and/or retrieval of the content 110. In this regard, the content 110 remains at the on-premise location 104.

At 304, the content 110 may be stored in the on-premise resource 116 (i.e., the printer driver of the computing and storage device 142 may connect to the on-premise resource 116 as illustrated by the arrow adjacent (304)). For example, the appliance 126 may include the on-premise storage 122 for storage of the content 110, and the on-premise processor 130 for processing of the content 110.

At 306, a user interface of the printing device 124 may lead to retrieval of the content 110.

At 308, the printing device 124 may pull the content 110 from the local resource (e.g., the on-premise storage 122), as illustrated by the arrow adjacent (308).

For the pull-print scenario described herein with respect to FIG. 3, depending on where a user initiates the pull-print of the content 110, the apparatus 100 may implement different objectives as specified by the policies 112 (or the policies 140 as disclosed herein). For example, if the user went to the on-premise printing device 124, the on-premise printing device 124 performs a login to the cloud environment 106, and the cloud environment 106 instructs the on-premise printing device 124 to pull the content 110 from the on-premise storage 122. In this scenario, the performance and costs associated with the pull-print process are maximized by optimized by retaining the content 110 on the on-premise location 104.

For the pull-print scenario described herein with respect to FIG. 3, alternatively, if the user went to their home printer, the home printer performs a login to the cloud environment 106, and the cloud environment 106 pulls the content 110 from the apparatus 100 in order to fulfill the print job on the home printer. The associated policy would allow jobs to be printed anywhere in the world as long as the user logs in to the cloud environment 106. In this scenario, the cost of transmitting the content 110 to the cloud environment 106 is incurred when the user is off-premise.

If the apparatus 100 is configured to prevent allowing any content from being printed on printers outside a firewall, the user would receive a message informing them of that policy. In this regard, the associated policy may be designated as a security policy.

The apparatus 100 may use its processing resources (i.e., the on-premise processor 130) to inspect the content, and allow/disallow off premise printing based on keywords. For example, the content may include a document that is inspected to allow/disallow off premise printing based on keywords.

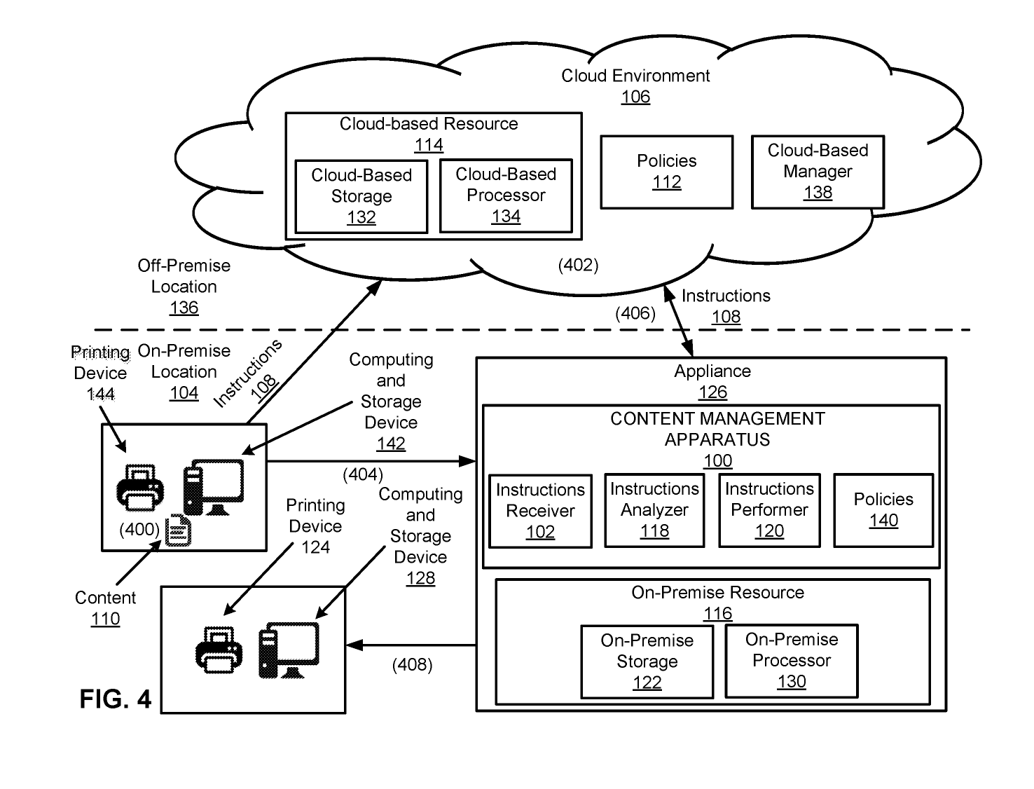

FIG. 4 illustrates a capture and route operation for the apparatus 100, according to an example of the present disclosure.

With respect to the capture and route operation for the apparatus 100, a printing device 144 (when used as a scanner) may be used to capture the content 110, where the apparatus 100 then routes the captured content 110 to its appropriate location.

Referring to FIG. 4, at 400, for the capture and route operation for the apparatus 100, a user may access the content 110 via a user interface of the printing device 144, which leads to scanning of the content 110.

At 402, the cloud-based manager 138 may coordinate the use of the on-premise resource 116 for processing of the content 110. In this regard, the content 110 remains at the on-premise location 104.

At 404, the content 110 may be stored in the on-premise resource 116 (as illustrated by the arrow adjacent (404)). For example, the appliance 126 may include the on-premise storage 122 for storage of the content 110, and the on-premise processor 130 for processing of the content 110.

At 406, the cloud-based manager 138 may direct the apparatus 100, or otherwise coordinate with the apparatus 100 so that the on-premise processor 130 is used to process the scanned content 110.

At 408, the content 110 may be routed to a final further on-premise storage location (e.g., the computing and storage device 128, as illustrated by the arrow adjacent (408)).

A policy (of the policies 112, or policies 140 as disclosed herein) associated with the capture and route operation for the apparatus 100 may include use of the on-premise processor 130 of the apparatus 100 to inspect the scanned content 110 based on key words, and to allow or disallow sending this particular content 110 to an off-premise cloud storage.

In some examples, the elements of the apparatus 100 may be machine readable instructions stored on a non-transitory computer readable medium. In this regard, the apparatus 100 may include or be a non-transitory computer readable medium. In some examples, the elements of the apparatus 100 may be hardware or a combination of machine readable instructions and hardware.

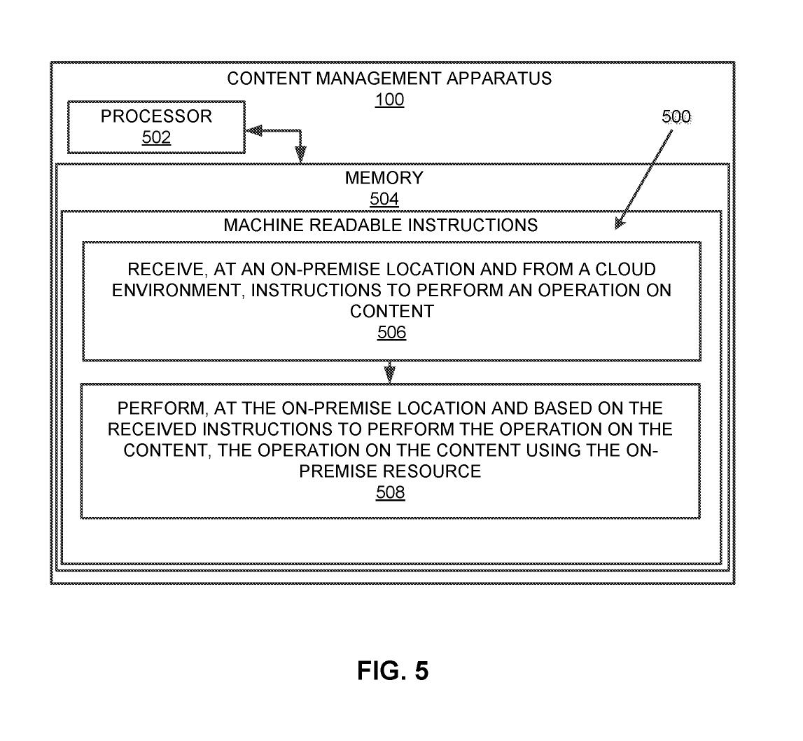

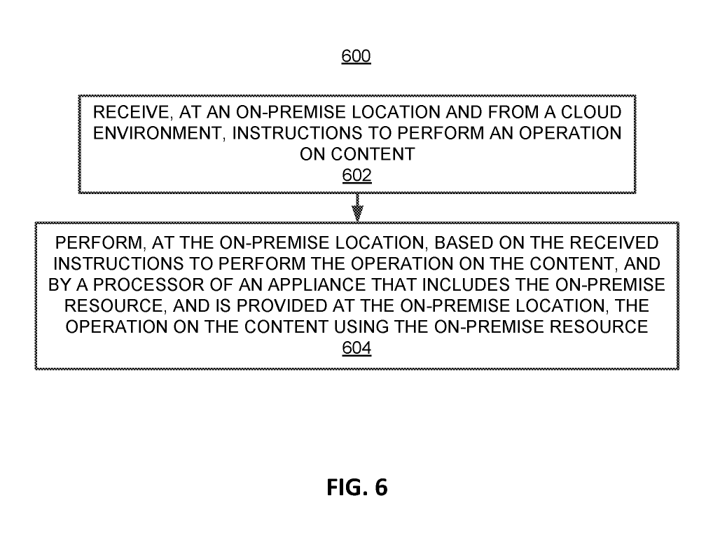

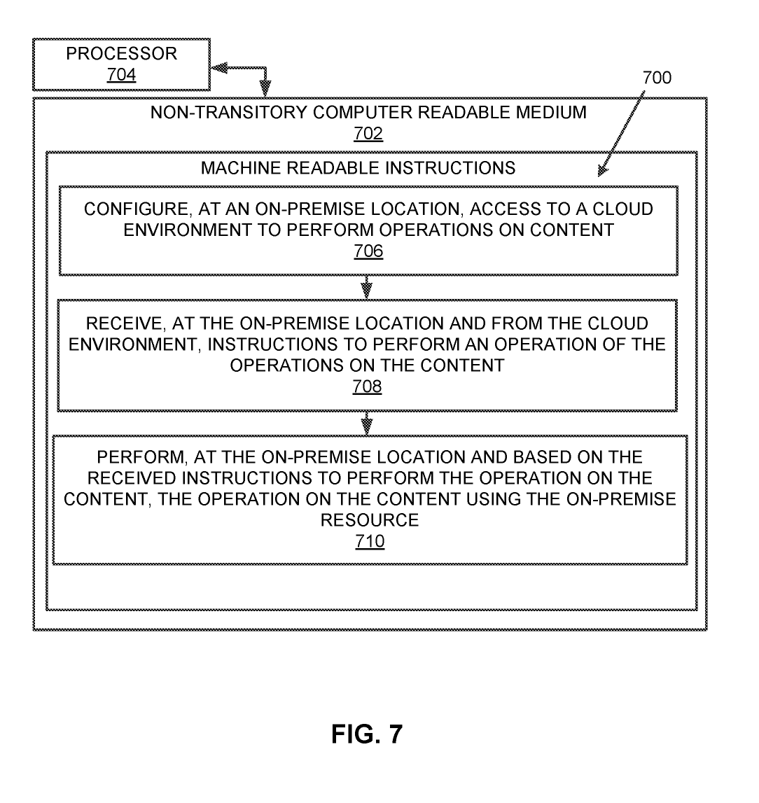

FIGS. 5-7 respectively illustrate flowcharts of methods 500, 600, and 700 for content management, according to examples. The methods 500, 600, and 700 may be implemented on the apparatus 100 described above with reference to FIGS. 1-4 by way of example and not limitation. The methods 500, 600, and 700 may be practiced in other apparatus. In addition to showing the method 500, FIG. 5 shows hardware of the apparatus 100 that may execute the method 500. The hardware may include a processor 502, and a memory 504 storing machine readable instructions that when executed by the processor cause the processor to perform the steps of the method 500 (the processor 502 may be the on-premise processor 130). The memory 504 may represent a non-transitory computer readable medium. FIG. 6 may represent a method for content management, and the steps of the method. FIG. 7 may represent a non-transitory computer readable medium 702 having stored thereon machine readable instructions to provide content management. The machine readable instructions, when executed, cause a processor 704 (where the processor 704 may be the on-premise processor 130) to perform steps of the method 700 also shown in FIG. 7.

The processor 502 of FIG. 5 and/or the processor 704 of FIG. 7 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 702 of FIG. 7), such as hardware storage devices (e.g., RAM (random access memory), ROM (read only memory), EPROM (erasable, programmable ROM), EEPROM (electrically erasable, programmable ROM), hard drives, and flash memory). The memory 504 may include a RAM, where the machine readable instructions and data for a processor may reside during runtime.

Referring to FIGS. 1-5, and particularly to the method 500 shown in FIG. 5, at block 506, the method 500 may include receiving, at the on-premise location 104 and from the cloud environment 106, instructions 108 to perform an operation on the content 110. The instructions 108 to perform the operation on the content 110 are previously received at the cloud environment 106 and further evaluated at the cloud environment 106 to determine, based on the plurality of policies 112 associated with the instructions 108 to perform the operation on the content, whether to perform the operation using the cloud-based resource 114 or whether to perform the operation using an on-premise resource 116 that is at the on-premise location 104. Further, in response to a determination, at the cloud environment 106, that the operation is to be performed using the on-premise resource 116, the instructions 108 to perform the operation on the content 110 are forwarded from the cloud environment 106 to the on-premise location 104.

At block 508, the method 500 may include performing, at the on-premise location 104 and based on the received instructions 108 to perform the operation on the content 110, the operation on the content 110 using the on-premise resource 116.

According to examples, as disclosed herein with respect to FIG. 3, the method 500 may further include determining, at the on-premise location 104, whether the instructions 108 to perform the operation on the content 110 include pull-print instructions. In response to a determination, at the on-premise location 104, that the instructions 108 to perform the operation on the content 110 include the pull-print instructions, the content 110 may be stored at the on-premise resource 116 that includes the on-premise storage 122. Further, upon receipt of a request from the printing device 124 at the on-premise location 104, the stored content 110 may be forwarded from the on-premise storage 122 to the printing device 124.

According to examples, for the method 500, storing the content 110 at the on-premise resource 116 that includes the on-premise storage 122 may further include storing the content 110 at the on-premise resource 116 that includes the on-premise storage 122 of the appliance 126 provided at the on-premise location 104.

According to examples, as disclosed herein with respect to FIG. 4, the method 500 may further include determining, at the on-premise location 104, whether the instructions 108 to perform the operation on the content 110 include capture and route instructions. In response to a determination, at the on-premise location 104, that the instructions to perform the operation on the content 110 include the capture and route instructions, the method 500 may include receiving a scanned version of the content 110, storing the scanned version of the content 110 at the on-premise resource that includes an on-premise storage 122, and routing, based on an analysis of the scanned version of the content 110 at the on-premise location 104, the scanned version of the content 110 to a further on-premise storage (e.g., the computing and storage device 128).

According to examples, for the method 500, storing the scanned version of the content 110 at the on-premise resource 116 that includes the on-premise storage 122 may further include storing the scanned version of the content 110 at the on-premise resource 116 that includes the on-premise storage 122 of the appliance 126 provided at the on-premise location 104.

According to examples, for the method 500, routing, based on the analysis of the scanned version of the content 110 at the on-premise location 104, the scanned version of the content 110 to the further on-premise storage (e.g., the computing and storage device 128) may further include routing, based on the analysis of the scanned version of the content 110 at the on-premise resource 116 that includes the on-premise processor 130, the scanned version of the content 110 to the further on-premise storage (e.g., the computing and storage device 128).

Referring to FIGS. 1-4 and 6, and particularly FIG. 6, for the method 600, at block 602, the method may include receiving, at the on-premise location 104 and from the cloud environment 106, instructions 108 to perform an operation on the content 110. The instructions 108 to perform the operation on the content 110 are previously received at the cloud environment 106 and further evaluated at the cloud environment 106 to determine, based on a plurality of policies 112 associated with the instructions 108 to perform the operation on the content 110, whether to perform the operation using the cloud-based resource 114 or whether to perform the operation using the on-premise resource 116 that is at the on-premise location 104. In response to a determination, at the cloud environment 106, that the operation is to be performed using the on-premise resource 116, the instructions 108 to perform the operation on the content 110 are forwarded from the cloud environment 106 to the on-premise location 104.

At block 604, the method may include performing, at the on-premise location 104, based on the received instructions 108 to perform the operation on the content 110, and by the on-premise processor 130 of the appliance 126 that includes the on-premise resource 116, and is provided at the on-premise location 104, the operation on the content 110 using the on-premise resource 116.

Referring to FIGS. 1-4 and 7, and particularly FIG. 7, for the method 700, at block 706, the method may include configuring, at the on-premise location 104, access to the cloud environment 106 to perform operations on the content 110.

At block 708, the method may include receiving, at the on-premise location 104 and from the cloud environment 106, instructions 108 to perform an operation of the operations on the content 110. The instructions 108 to perform the operation on the content 110 are previously received at the cloud environment 106 and further evaluated at the cloud environment 106 to determine, based on a plurality of policies 112 associated with the instructions 108 to perform the operation on the content 110, whether to perform the operation using the cloud-based resource 114 or whether to perform the operation using the on-premise resource 116 that is at the on-premise location 104. Further, in response to a determination, at the cloud environment 106, that the operation is to be performed using the on-premise resource 116, the instructions 108 to perform the operation on the content 110 are forwarded from the cloud environment 106 to the on-premise location 104.

At block 710, the method may include performing, at the on-premise location 104 and based on the received instructions 108 to perform the operation on the content 110, the operation on the content 110 using the on-premise resource 116.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A content management apparatus comprising:
a processor; and
a memory storing machine readable instructions that when executed by the processor cause the processor to:
receive, at an on-premise location and from a cloud environment, instructions to perform an operation on content, wherein
the instructions to perform the operation on the content are previously received at the cloud environment and further evaluated at the cloud environment to determine, based on a plurality of policies associated with the instructions to perform the operation on the content, whether to perform the operation using a cloud-based resource or whether to perform the operation using an on-premise resource that is at the on-premise location, and
in response to a determination, at the cloud environment, that the operation is to be performed using the on-premise resource, the instructions to perform the operation on the content are forwarded from the cloud environment to the on-premise location; and
perform, at the on-premise location and based on the received instructions to perform the operation on the content, the operation on the content using the on-premise resource.

2. The content management apparatus according to claim 1, wherein the machine readable instructions, when executed by the processor, further cause the processor to:
determine, at the on-premise location, whether the instructions to perform the operation on the content include pull-print instructions; and
in response to a determination, at the on-premise location, that the instructions to perform the operation on the content include the pull-print instructions,
store the content at the on-premise resource that includes an on-premise storage, and
forward, upon receipt of a request from a printing device at the on-premise location, the stored content from the on-premise storage to the printing device.

3. The content management apparatus according to claim 2, wherein the machine readable instructions to store the content at the on-premise resource that includes the on-premise storage further comprise machine readable instructions to cause the processor to:
store the content at the on-premise resource that includes the on-premise storage of an appliance provided at the on-premise location.

4. The content management apparatus according to claim 1, wherein the machine readable instructions, when executed by the processor, further cause the processor to:
determine, at the on-premise location, whether the instructions to perform the operation on the content include capture and route instructions; and
in response to a determination, at the on-premise location, that the instructions to perform the operation on the content include the capture and route instructions,
receive a scanned version of the content,
store the scanned version of the content at the on-premise resource that includes an on-premise storage, and
route, based on an analysis of the scanned version of the content at the on-premise location, the scanned version of the content to a further on-premise storage.

5. The content management apparatus according to claim 4, wherein the machine readable instructions to store the scanned version of the content at the on-premise resource that includes the on-premise storage further comprise machine readable instructions to cause the processor to:
store the scanned version of the content at the on-premise resource that includes the on-premise storage of an appliance provided at the on-premise location.

6. The content management apparatus according to claim 4, wherein the machine readable instructions to route, based on the analysis of the scanned version of the content at the on-premise location, the scanned version of the content to the further on-premise storage further comprise machine readable instructions to cause the processor to:
route, based on the analysis of the scanned version of the content at the on-premise resource that includes the processor, the scanned version of the content to the further on-premise storage.

7. A method for content management, the method comprising:
receiving, at an on-premise location and from a cloud environment, instructions to perform an operation on content, wherein
the instructions to perform the operation on the content are previously received at the cloud environment and further evaluated at the cloud environment to determine, based on a plurality of policies associated with the instructions to perform the operation on the content, whether to perform the operation using a cloud-based resource or whether to perform the operation using an on-premise resource that is at the on-premise location, and
in response to a determination, at the cloud environment, that the operation is to be performed using the on-premise resource, the instructions to perform the operation on the content are forwarded from the cloud environment to the on-premise location; and
performing,
at the on-premise location,
based on the received instructions to perform the operation on the content, and
by a processor of an appliance that
includes the on-premise resource, and
is provided at the on-premise location,
the operation on the content using the on-premise resource.

8. The method according to claim 7, further comprising:
determining, at the on-premise location, whether the instructions to perform the operation on the content include pull-print instructions; and
in response to a determination, at the on-premise location, that the instructions to perform the operation on the content include the pull-print instructions,
storing the content at the on-premise resource that includes an on-premise storage, and
forwarding, upon receipt of a request from a printing device at the on-premise location, the stored content from the on-premise storage to the printing device.

9. The method according to claim 7, further comprising:
determining, at the on-premise location, whether the instructions to perform the operation on the content include capture and route instructions; and
in response to a determination, at the on-premise location, that the instructions to perform the operation on the content include the capture and route instructions,
receiving a scanned version of the content,
storing the scanned version of the content at the on-premise resource that includes an on-premise storage, and
routing, based on an analysis of the scanned version of the content at the on-premise location, the scanned version of the content to a further on-premise storage.

10. The method according to claim 9, wherein routing, based on the analysis of the scanned version of the content at the on-premise location, the scanned version of the content to the further on-premise storage further comprises:
routing, based on the analysis of the scanned version of the content at the processor, the scanned version of the content to the further on-premise storage.

11. A non-transitory computer readable medium having stored thereon machine readable instructions to provide content management, the machine readable instructions, when executed, cause a processor to:
configure, at an on-premise location, access to a cloud environment to perform operations on content;
receive, at the on-premise location and from the cloud environment, instructions to perform an operation of the operations on the content, wherein
the instructions to perform the operation on the content are previously received at the cloud environment and further evaluated at the cloud environment to determine, based on a plurality of policies associated with the instructions to perform the operation on the content, whether to perform the operation using a cloud-based resource or whether to perform the operation using an on-premise resource that is at the on-premise location, and
in response to a determination, at the cloud environment, that the operation is to be performed using the on-premise resource, the instructions to perform the operation on the content are forwarded from the cloud environment to the on-premise location; and
perform, at the on-premise location and based on the received instructions to perform the operation on the content, the operation on the content using the on-premise resource.

12. The non-transitory computer readable medium of claim 11, further comprising machine readable instructions, when executed, further cause the processor to:
determine, at the on-premise location, whether the instructions to perform the operation on the content include pull-print instructions; and
in response to a determination, at the on-premise location, that the instructions to perform the operation on the content include the pull-print instructions,
store the content at the on-premise resource that includes an on-premise storage, and
forward, upon receipt of a request from a printing device at the on-premise location, the stored content from the on-premise storage to the printing device.

13. The non-transitory computer readable medium of claim 12, wherein the machine readable instructions to store the content at the on-premise resource that includes the on-premise storage, when executed, further cause the processor to:
store the content at the on-premise resource that includes the on-premise storage of an appliance provided at the on-premise location.

14. The non-transitory computer readable medium of claim 11, further comprising machine readable instructions, when executed, further cause the processor to:
determine, at the on-premise location, whether the instructions to perform the operation on the content include capture and route instructions; and
in response to a determination, at the on-premise location, that the instructions to perform the operation on the content include the capture and route instructions,
receive a scanned version of the content,
store the scanned version of the content at the on-premise resource that includes an on-premise storage, and
route, based on an analysis of the scanned version of the content at the on-premise location, the scanned version of the content to a further on-premise storage.

15. The non-transitory computer readable medium of claim 14, wherein the machine readable instructions to store the scanned version of the content at the on-premise resource that includes the on-premise storage, when executed, further cause the processor to:
store the scanned version of the content at the on-premise resource that includes the on-premise storage of an appliance provided at the on-premise location.
